(19) United States
(12) Patent Application Publication
(10) Pub. No.: US 2003/0108854 A1
(43) Pub. Date: Jun. 12, 2003

(54) Book that can read languages and sentences

(75) Inventor: Chi Kuen Chan, Kwai Chung (HK)

Correspondence Address: SEED INTELLECTUAL PROPERTY LAW GROUP PLLC, 701 FIFTH AVE, SUITE 6300, SEATTLE, WA, 98104-7092, US

(73) Assignee: Wide Concepts Limited, Wan Chai (HK)

(21) Appl. No.: 10/064,351

(22) Filed: Jul. 3, 2002

(30) Foreign Application Priority Data
Dec. 12, 2001 (CN) 01278183.5

(51) Int. Cl. G09B 5/00

(52) U.S. Cl. 434/317; 434/169; 434/365

(57) ABSTRACT

A book, mainly used by children and students, consists of a book and a speech circuit. A printed circuit board containing press triggers is placed inside the cover of the book. A number of speech switches in the book correspond to the positions of pictures in the book. In the book, the speech circuit includes circuit for storage and sound emission, a speaker and a battery, all of which are in a box-like container linked with the book. When reading the book, press a picture in a page, the speech switch would be switched on. Based on preset programs and storage, the circuit for storage and sound emission enables the speaker to read aloud the language of the page, which may be Chinese or foreign languages, etc. Corresponding to the content of the book, the sound can be dialogue between animals. This makes learning a language easy and interesting.

### BACKGROUND OF THE INVENTION

1. Field of the Invention

The present utility model relates to a kind of book, particularly the kind of book for minors that can read languages and sentences.

2. Description of the Related Art

Education is a large-scale industry. The pre-school education and foreign language education depend on reading. Many factories consider how to arouse the interest of minors or even the students and parents to study and how to make books more interesting. At present, all the books are only printed in words that cannot read aloud themselves. If there are books that can read languages and sentences, it would be welcomed by the market.

### BRIEF SUMMARY OF THE INVENTION

An embodiment of the present invention provides for minors books that can read aloud languages and sentences.

It is a kind of book which can speak languages and sentences. It is a book that includes a speech circuit for reading out the specified sentences in the book. The speech circuit includes a printed circuit board containing press triggers on which there are a number of speech switches, a circuit for storage and sound emission, a speaker, and a battery. The printed circuit board containing press triggers is inside the cover of the book. The circuit for storage and sound emission, speaker, and battery are placed in a box-like container outside the book. The internal and external part of the speech circuit are connected by a wire. The circuit for storage and sound emission stores all the sound to be emitted. The speech switches are switched on when pressing different pictures on the book. The speaker would then read aloud the contents of the pictures. The battery supplies electricity for the whole circuit.

A book constructed in this manner can read aloud the sentences in the book and the contents of the books. Matching with the pictures in the books, it is particularly suitable for pre-school education and learning of foreign language by children. Not only they benefit the learning of children and students, they also facilitate assistance from parents to the children. With the assistance of this book, foreign language and common knowledge can be learned and it would also foster social morality.

### BRIEF DESCRIPTION OF THE DRAWINGS

FIG. 1 illustrates the appearance and structure of a book that can read languages and sentences according to an embodiment of the present invention.

FIG. 2 illustrates the speech circuit's block diagram of the book shown in FIG. 1.

FIG. 3 illustrates a page of the book shown in FIG. 1.

FIG. 4 illustrates another page of the book shown in FIG. 1.

FIG. 5A illustrates the speech circuit of the book shown in FIG. 1.

FIG. 5B is an amplification of part of the circuit for storage and sound emission (23) shown in FIG. 5A.

FIG. 6 illustrates another page of the book shown in FIG. 1.

The following is a detailed description, when combined with the attached figures, on the structural features of a book that can read languages and sentences according to an embodiment of the present invention.

### DETAILED DESCRIPTION OF THE INVENTION

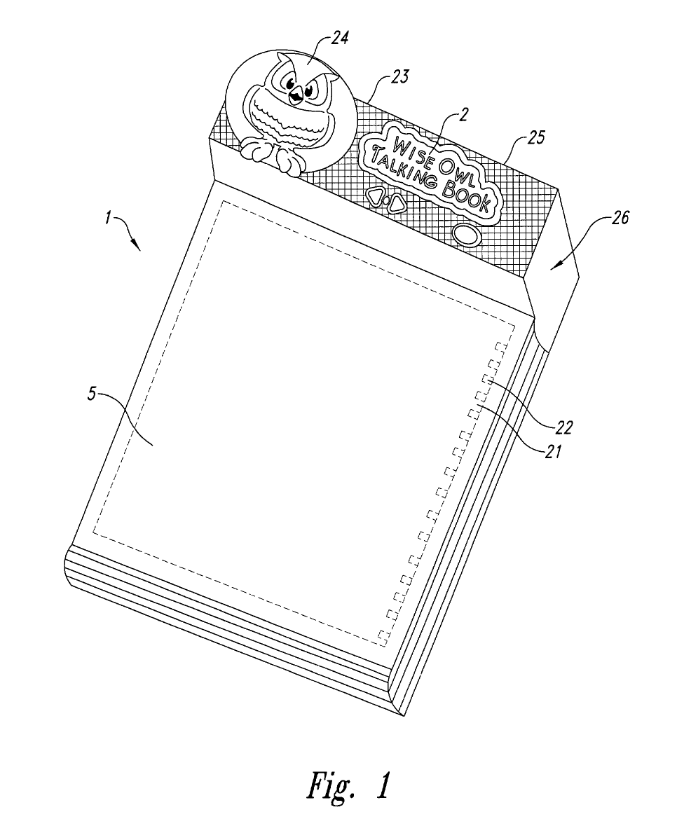

Referring to FIG. 1. FIG. 1 illustrates the appearance and structure of a book that can read languages and sentences according to an embodiment of the present invention. The present book includes a book (1) and a speech circuit (2). A press trigger printed circuit board (PCB) (21) of the speech circuit (2) is placed inside the cover of the book. A hard cover is preferred to reduce the possibility of damage of the press trigger PCB (21) caused by bending and rubbing. In the book, a rub-proof insulating soft film is used as the substrate of the press trigger PCB, i.e., one can place the soft film press trigger PCB (21) inside the cover of the book. It can be placed in the soft cover of a book. Of course, any other press trigger PCB with similar capabilities can be used. The box-like container (26) shown in FIG. 1 shows a circuit for storage and sound emission (23), a speaker (24) and a battery (25). The box-like container can usually be connected to the book (1) in a fixed manner. The box-like container (26) can be manufactured in a number of interesting shapes, for example, in the form of a pencil box. To match the content of the book, it can be in the shape of a candy box and a dressing case for cosmetics, etc. The box can become a toy book or a learning book, etc. to increase the spectrum of customers for the book. In relation to the circuit for storage and sound emission (23), it adopts the IC block HE80320 AND HE167340 or similar circuit (not limited to such models).

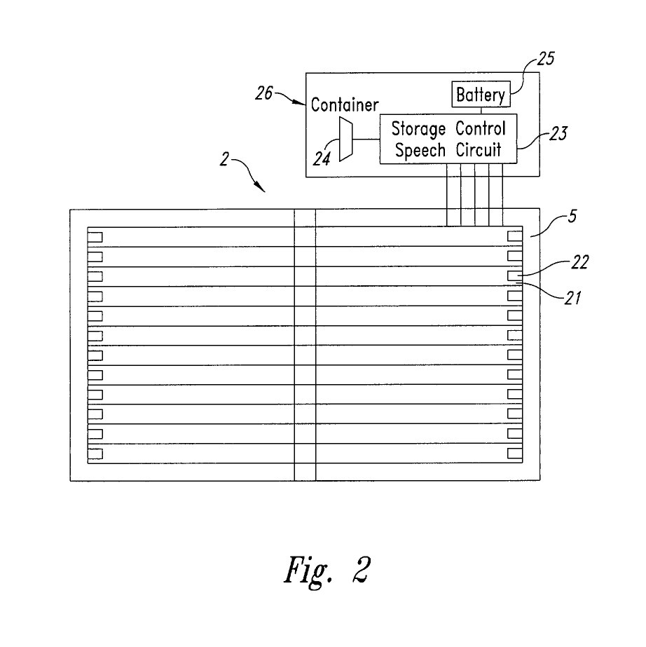

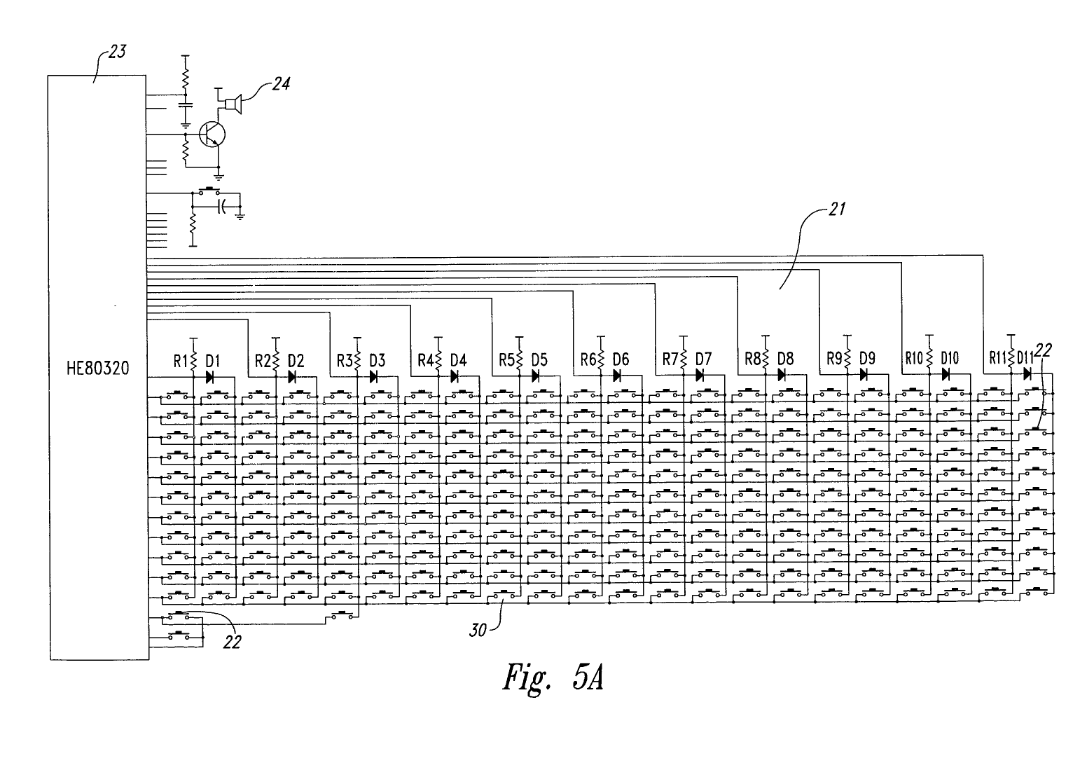

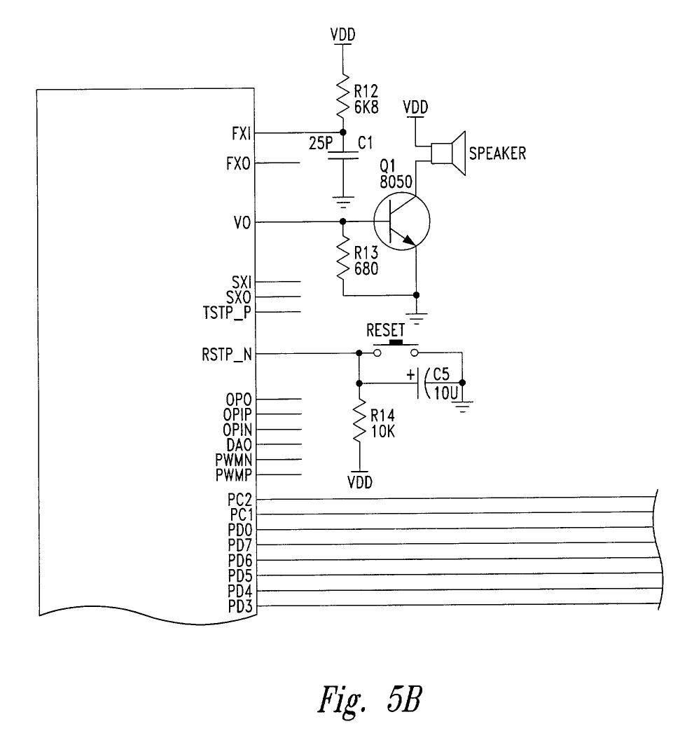

Referring to FIG. 2. FIG. 2 illustrates the speech circuit's (2) block diagram of a book that can read languages and sentences' according to the present utility model shown in FIG. 1. As shown in FIG. 2, a large piece of printed circuit board with press triggers (21) with a number of speech switches (30) on it (shown in FIG. 5A), is placed inside the cover of the book. The outer cover of the book is marked as label 5. The figure shows that the outer cover is open. The box-like container (26) contains a speaker (24), a circuit for storage and sound emission (23) and a battery (25). The thin film circuit on the press trigger PCB (21) is connected to circuit for storage and sound emission (23) so that the whole circuit can have electricity. Usually, the battery is used to supply electricity to the whole circuit so that the book becomes portable. All the sound of the languages would be entered into and recorded in advance in the circuit for storage and sound emission (23). When the speech switch for sound emission (30) is pressed and that part of circuit connected, the circuit for storage and sound emission (23) for that speech switch would be connected according to the configuration of the circuit.

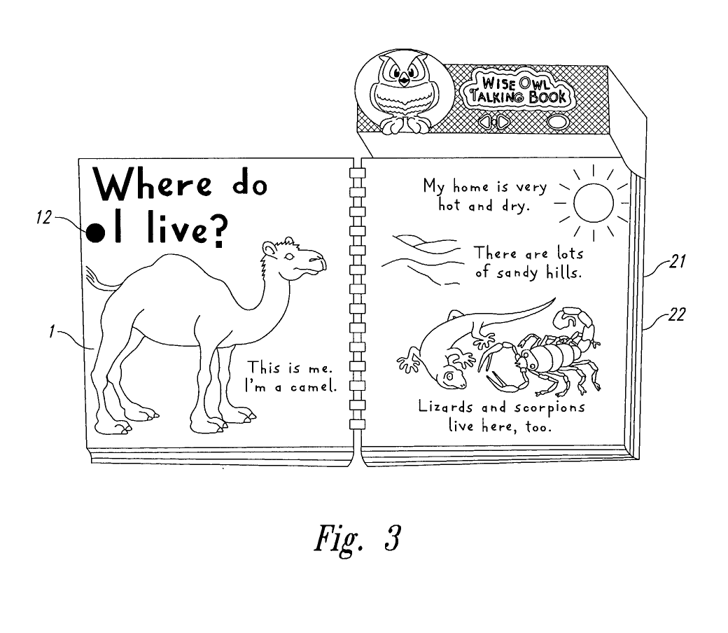

Furthermore, a number of press trigger switches (22) can be arranged near the margins of the press trigger PCB (21) (FIG. 3). On every page, there is a spot above each press trigger (22) (FIG. 3). The purpose of this structure is to enable matching of the spot on each page with the press-trigger on the circuit. When turning to a certain page, one can press a page selection contact (12) to switch on the corresponding press-trigger switch (22), and then press or touch the pictures on that page to switch on the corresponding press trigger switch (30). The speaker would emit sound reading out aloud the pre-recorded sound associated with the selected pictures. If you directly press the pictures without pressing the page selection contact, the sound coming out would not correspond to the picture on the selected page but to that of the previous page or the next page.

The function keys of repeat and stop can be inserted by setting up switches. These functions can be left out. The operation procedure can be in various ways decided by the Manufacturing factory.

Referring to FIG. 3. FIG. 3 illustrates the location of the page selection contact of the book shown in FIG. 1. On the margin of every page, there is a circular page selection contact (12) shown in FIG. 3. Circular contact is used only as an example. Of course, any other shapes can be used. One can press this contact (12) to switch on the corresponding press trigger switch (22) located inside the cover of the book, then press the different pictures to switch on the corresponding speech switches (30). The sound corresponding to the different pictures can be sent out. For the picture shown in FIG. 3, one can press the page selection contact (12) on this page, then press the camel on the left and upper part of the page, it will read aloud “This is me, I'm a camel”. If one presses the sun on the top right hand corner, it will read aloud “My home is very hot and dry.”. The voice that comes out would differ depending on different books, different content, different languages used, different voices, different intonations and different sound effect.

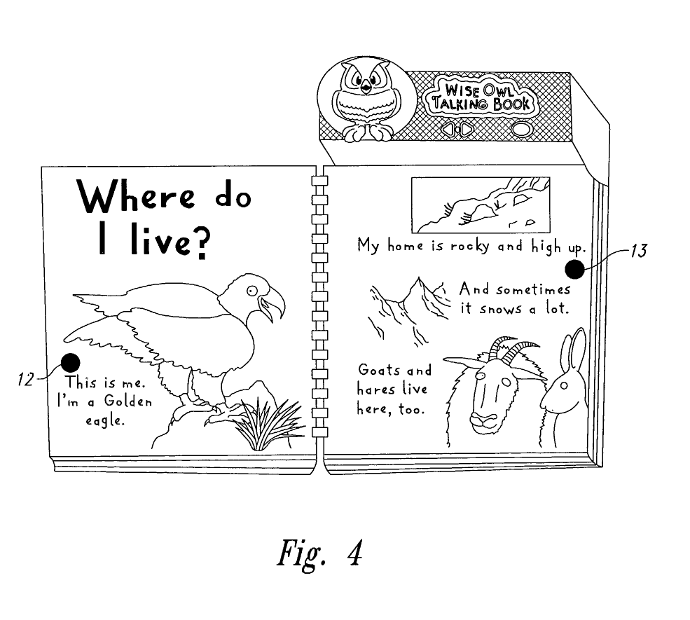

FIG. 4 shows the picture from a different page. Each time a page is turned, one must press the page selection contact (12) on the margin of the selected page first, then press the photographs on that page. Referring to the page shown in FIG. 4. First, press the page selection contact (12), then press the eagle on the left hand side and it will read aloud “This is me, I am a golden eagle”. Press the bottom at the right lower corner and it will read aloud “Goats and hares live here, too.” The purpose of the page selection contact (12) is to match the images on every page with the prerecorded voices correctly. If you press an image without pressing the page selection contact (12), it will emit the sound corresponding to the picture on the previous page.

Another way to deal with the problem is to insert a stop contact (13) on every page. After finishing a page, press the stop contact (13) to terminate the voice. Then turn to another page and press the page selection contact (12) to begin reading the new page. When finish reading, press the stop contact (13). If the stop contact (13) is not pressed, when reading another page, the previous page's voice will be repeated if the reader forgets to press the page selection contact (12). However, with the stop contact, when the reader reads another page, even if he forgets to press the page selection contact (12), the previous page's voice would not be repeated. There would be no sound.

There are many ways in placing the page selection contact (12) in the book. It is critical that the page selection contact must correspond in position with the press trigger switch (22) in the press trigger PCB (21). One page selection contact (12) corresponds in position only with one press trigger switch (22). Therefore, the page selection contact (12) on one page should not be in the same position as that of another page. For example, the selection contact on the fist page is placed on the top left corner. The selection contact of the second page is placed in a position lower than the selection contact of the first page. This continues so on and so forth). As to whether one selection contact controls 1 page or 2 pages when a book is in the open position, it does not really matters. This can be determined by the number of pages of the book and the number of selection contacts. All page selection contacts (12) are arranged along the margins and all stop contacts (13) are located at the same position, such as the top right hand corner of every page.

The press trigger PCB will not be damaged on opening the book or turning a page as it is soft and all the acts like opening a book and turning a page are taken into account in designing the book. The other number and symbols in FIG. 4 have the same meanings as those in FIG. 1 and FIG. 2.

FIG. 5A and FIG. 5B illustrate the speech circuit (2) of the book illustrated from FIG. 1 to FIG. 4. The present embodiment adopts IC block HE80320, associated with resistance R12, R13 and R14, a triode A1, capacitance C1 and C5 to form the circuit controlling storage and sound emission (23). The speaker (24) is also shown in the figure and the battery (25) powers the circuit system via VDD. The matrix part is the gum-film press trigger PCB (21) on which there are many speech switches (30) corresponding to the different pictures. The number of the speech switches (30) may be 242 (22 columns*11 rows) (of course, it can be increased or decreased according to the contents of the book or the number of the speech contacts). There are 11 resistances named from R1 to R11 and 11 diodes with which the circuit is made up to realize the speaking function of the book.

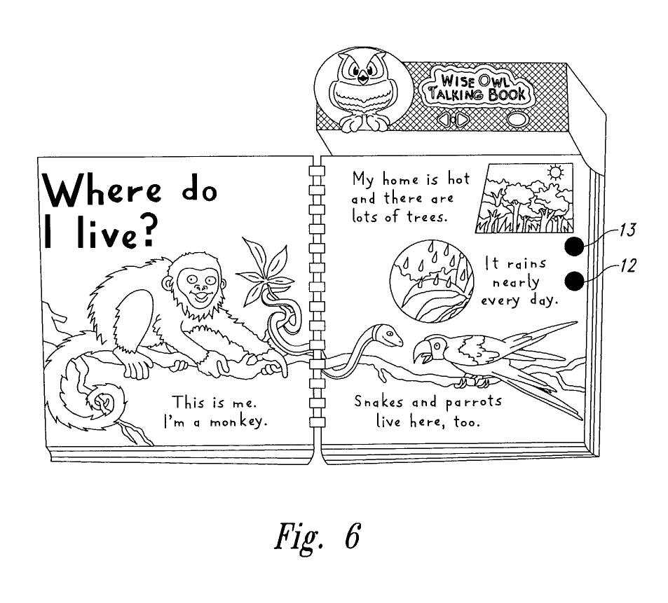

Referring to FIG. 6. FIG. 6 illustrates another page of the book according to the present utility model. On the top right hand corner of the figure, there is a box-like container (26) with a pencil case shape, which is linked with the book. On the left page of the book, there are some English words and a monkey. On the right page, there are some English words and a parrot. Between the right and left pages, there is a snake. On the right margin of the right page, there is a page selection contact (12) and a stop contact (13).

A book according to the present invention has wide application. Its content can be of great varieties. Because it is educational, it will be widely accepted.

All of the above U.S. patents, U.S. patent application publications, U.S. patent applications, foreign patents, foreign patent applications and non-patent publications referred to in this specification and/or listed in the Application Data Sheet, including but not limited to Chinese patent application no. 01278183.5 from which this application claims priority, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A book device that can read aloud sentences in one or more languages, comprising:
a book with a cover and pages that include pictures; and
a speech circuit that reads aloud information about the pictures in the book, the speech circuit including:
a printed circuit board containing speech switches, the printed circuit board being inside the cover of the book;
a speaker;
a battery connected to power the printed circuit board and speaker; and
a circuit for storage and sound emission connected to the printed circuit board, speaker and battery, wherein the circuit for storage and sound emission, speaker and battery are in a box-like container outside the book, and the circuit for storage and sound emission stores recorded sounds of the book, such that in response to a user pressing a picture on a selected page, a corresponding one of the speech switches will be switched on, which causes the circuit for storage and sound emission to cause the speaker to read aloud specified contents about the pressed picture.

2. A book device according to claim 1, whereinthe printed circuit board includes a plurality of press trigger switches and each page of the bookincludes a respective page selection contact corresponding in position to a respective one of the press trigger switches for page selection, wherein in response to a user turning to a certain page, pressing its page selection contact to turn on the corresponding press trigger switch, and then pressing a picture on the certain page to turn on the corresponding speech switch, the speech circuit cause the speaker to reads aloud words corresponding to the pressed picture on the certain page.

3. A book device according to claim 2, wherein the printed circuit board includes a substrate made of a durable soft film and containing the press triggers.

4. A book device according to claim 2 wherein the page selection contacts are placed on a margin of every page and the location of each page selection contact on each page is different from the locations of other page selection contacts for other pages.

5. A book device according to claim 1 wherein the circuit for storage and sound emission includes an IC block HE80320 or HE167340.

6. A book device according to claim 1 wherein the cover of the book is a hard cover.

7. A book device according to claim 1 wherein the box-like containerhas an appearance of a pencil box, a candy box, or a dressing case.

8. A book according to claim 1 wherein the box-like container is connected to the book in a fixed manner.

9. A book device according to claim 1 wherein the sentences that are being read aloud are in different voices and different tones depending on the page selected.

10. A book device according to claim 1 wherein the speech circuit includes a stop contact on every page to avoid emitting sound that does not correspond with the pictures on the page.

11. A book device according to claim 1, wherein the circuit for storage and sound emission stores sounds for each page in a plurality of languages that can be selected by a user.

12. A book device that can read aloud sentences in one or more languages, comprising:
a book with a cover and pages that include pictures; and
a speech circuit that reads aloud information about the pictures in the book, the speech circuit including:
a printed circuit board containing press-sensitive speech switches and positioned within the book;
a speaker; and
a storage and sound emission circuit connected to the printed circuit board and speaker, wherein the storage and sound emission circuit stores recorded sounds of the book, such that in response to a user pressing a picture on a selected page, a corresponding one of the speech switches will be switched on, which causes the circuit for storage and sound emission to cause the speaker to read aloud specified contents about the pressed picture.
